(19) United States
(12) Patent Application Publication
(10) Pub. No.: US 2014/0138974 A1
(43) Pub. Date: May 22, 2014

(54) VEHICLE MAT SYSTEM AND METHOD

(71) Applicants: Yaron MANTEL, Haifa (IL); Ravid PELEG, Kiryat Motzkin (IL)

(72) Inventors: Yaron MANTEL, Haifa (IL); Ravid PELEG, Kiryat Motzkin (IL)

(21) Appl. No.: 14/165,216

(22) Filed: Jan. 27, 2014

Related U.S. Application Data
(63) Continuation of application No. PCT/IL2012/000286, filed on Jul. 23, 2012.

(30) Foreign Application Priority Data
Jul. 28, 2011 (IL) 214338

(51) Int. Cl. B60J 11/00

(52) U.S. Cl. CPC B60J 11/00
USPC 296/3; 296/39.1

(57) ABSTRACT

A system and a method for preventing damage to a vehicle caused by a rack mounted thereon and by a load mounted on the rack. The system and the method use a leash and an alarm system to alert at least the driver when the load becomes disengaged from the rack. Thereby, the system and the method may prevent damage to other vehicles when the load becomes disengaged from the rack.

### CROSS REFERENCE TO RELATED APPLICATION

This application claims priority under 35 U.S.C. §119(e) of International Patent Application No. PCT/IL2012/000286 filed Jul. 23, 2012, the entire disclosure of which is incorporated by reference herein.

### TECHNICAL FIELD

The present invention relates to a system and to a method for preventing damage to a vehicle, and more particularly, to prevent damage caused to the vehicle by a load support mounted thereon and from a load mounted on the load support, as well as to prevent damage to other vehicles.

### BACKGROUND ART

Protection of bicycles and of vehicles has been dealt with in the following US patents.

U.S. Pat. No. 3,968,913 to Weed et al. reveals a protective cover for a frame mounted bicycle which may be readily closed and opened to facilitate easy mounting and dismounting of the bicycle from the carrying frame.

Similarly, U.S. Pat. No. 5,062,560 to Wasden discloses an apparatus in the nature of a flexible cover attached to a bicycle that is being transported by a vehicle, such as when mounted on a car top bicycle carrier. The cover is made of a stretchable material and has waterproof portions adapted to keep the seat dry while being transported.

In addition, U.S. Pat. No. 6,508,484 to Flemons teaches a bicycle protector which comprises a cushioning cover that folds, in use, along a substantially centralized longitudinal or transverse axis to thereby drape over a wheeled bicycle to cover at least the bicycle frame from the right and left hand sides to a substantially equal extent and having fastening means, to secure the cover in place by attachment to or around the bicycle or a part thereof, the cover being filled in use throughout its extent with a cushioning material to protect the bicycle frame from damage in storage or transit.

US Application No. 2003/0138620 to Fonseca reveals a flexible magnetic mat comprising a top layer of rubberized material adhered to a bottom layer of a flexible magnetic layer. The mat can be utilized to protect the metal surface of a roof or an interior floor of a vehicle when any heavy article is laid on top of the mat.

U.S. Pat. No. 2,790,584 to Rahn, referred to herinbelow as Rahn, divulges a mat disposed on a vehicle and retained thereto by straps, which are coupled to the mat by a rivet extending through the straps and through the mat. Such a rivet may cause damage to the surface to the vehicle. Furthermore, Rahn does not recite a leash coupled directly by a first and end to the load and by a second end to the vehicle to prevent loss of the load in case of detachment from the straps, where the leash retains the load attached on the vehicle.

U.S. Patent Application No. 2010/0007500 to Mestres et al., referred to hereinbelow as Mestres, discloses a computerized electronic system for detecting and for locating an object that has fallen off a vehicle. Such a system does not prevent an object from falling off a vehicle and is superfluous when a leash is coupled by a first end to the vehicle and by the second end to the vehicle to prevent detachment therefrom.

In contrast thereto, the present disclosure recites protection of the surface of a vehicle from a rack, from a load mounted on the rack, and protection to other vehicles should the load become detached from the rack.

### SUMMARY OF INVENTION

The embodiments of the present invention provide a system having a mat, as well as a method for using the mat, to protect a vehicle from a load support that is mounted thereon, and to protect the vehicle from a load supported by the load support. The rack and the load may rub against the surface of the vehicle, scratch, dent, and otherwise damage the surface. Moreover, the mat system prevents the load from falling off the rack and endanger other vehicles.

A mat is draped and securely attached upon a surface of the vehicle with magnets, for example upon a rear baggage door of the vehicle. The rack is mounted on the mat and attached to the vehicle by means of straps, and the rack is provided with means for mounting the load thereon.

It is an object of the embodiments of the present invention to prevent damage caused to a surface S of a vehicle V. The system comprises a rack R mounted on the vehicle and a load L supported by the rack. The mat 10 is made of pliable and foldable material and has a first mat side M1 and a second mat side M2, the second mat side being draped in contact over the surface for preventing damage thereto. The mat has at least one opening 25 opened for passage from the first mat side to the second mat side, where the at least one opening is selected from a group consisting of a permanently open opening and a reversibly closeable opening. Furthermore, the mat is disposed intermediate between the rack and the surface for protection thereof from damage caused by the rack and by the load.

It is another object of the present invention to provide the mat with a safety leash 30 having a first leash end 31 configured for reversible fixed coupling to the load L, and a second leash end 32 configured for reversible fixed coupling to the vehicle V, where the safety leash is configured to prevent unintentional detachment of the load from the vehicle, and to prevent the load from causing damage to other vehicle(s) OVS.

It is yet another object of the embodiments of the present invention to provide a sensing device 35 configured to operate in association with the safety leash 30 to detect unintentional disengagement of the load L from the rack R, and an alarm system 60 coupled to the sensing device, where the alarm system is configured to deliver an alert signal to at least a driver D of the vehicle V when the load becomes detached from the rack.

It is still another object of the embodiments of the present invention for the rack R to include at least one strap 26 having a strap-rack-end 26R fixedly attached to the rack and a strap-vehicle-end 26V fixedly but releasably coupled to the vehicle, where the at least one strap is loaded in tension to bias the rack against the vehicle, and where the at least one opening 25 in the mat 10 is configured for passage therethrough of the at least one strap.

It is moreover another object of the embodiments of the present invention to provide the at least one reversibly closeable opening 28 to be configured to allow to uncover at least one of a predetermined portion of the surface PDS, and for the predetermined portion of the surface PDS to be selected alone and in combination from a group including a license plate of the vehicle and a lock of the vehicle.

It is furthermore another object of the embodiments of the present invention to provide the mat 10 with a mat pocket 20 for storing therein at least the safety leash 30, and for the mat to have optical reflective material 40 attached to the first mat side M1, where the mat is foldable.

It is yet an object of the embodiments of the present invention to provide the rack R as a bicycle rack and for the load L to include at least one bicycle. Furthermore, the mat may be draped onto a trunk door TD of the vehicle V.

It is still an object of the embodiments of the present invention to provide the alarm system 60 to be disposed on one of the safety leash 30 and in the vehicle V and for the alert signal to selected alone and in combination from a group including a visual alert signal, and an audio alert signal. Moreover, the mat pocket 20 may be configured for storing therein accessories ACC including a license plate LP configured for attachment to one of the load L, the rack R, and the mat 10.

### Technical Problem

A rack mounted upon a surface of a vehicle and a load mounted on the rack, may scratch, dent, or otherwise damage the surface, while the rack is being mounted on the vehicle and/or during motion of the vehicle. Moreover, the load may become disengaged from the rack particularly while the vehicle is being driven. Such a fall of the load may cause damage not only to the vehicle that carried the load, but also to other vehicles on the road. A driver of the vehicle might even not be aware that such load disengagement occurred.

### Solution to Problem

A mat may be disposed and securely attached to a relevant portion of the surface of the vehicle intermediate between the rack and the surface of the vehicle. The mat prevents damage, such as for example, dents, scratches or nicks, to the surface caused by both the rack and the load. The mat may be provided with a safety leash having two ends, where the first end is securely attached to the vehicle and the second end is attached to the load. Should the load become disengaged from the rack, particularly during movement of the vehicle, the mat will prevent damage to the vehicle, and furthermore, the safety leash will prevent the load from being lost, from bouncing on the road and from colliding with and damaging other vehicles. An alarm system connected to a sensing device coupled to the safety leash may alert at least the driver that the load has fallen off the rack.

### BRIEF DESCRIPTION OF DRAWINGS

Non-limiting embodiments of the invention will be described with reference to the following description of exemplary embodiments, in conjunction with the figures.

FIG. 1 is a schematic view of the mat with the safety leash,

FIG. 2 is a block diagram of the system, and

FIG. 3 is a rear view of a vehicle showing the mat draped over a trunk door onto which a rack is strapped.

### DESCRIPTION OF EMBODIMENTS

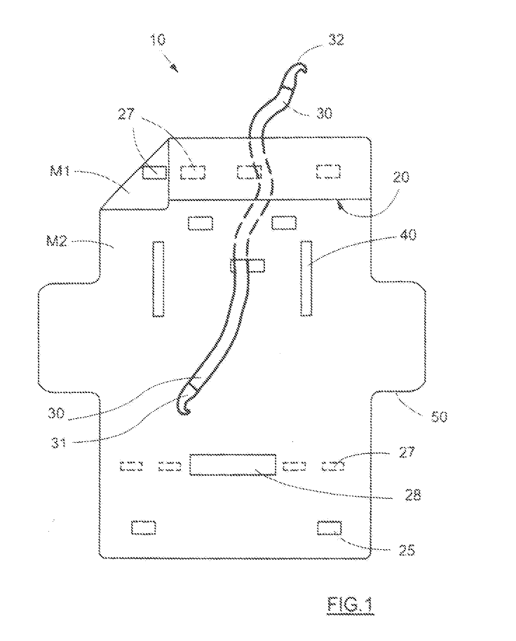

With reference to FIGS. 1 to 3, there is shown a mat 10 which is configured to be disposed onto a surface of a vehicle V, for example on the rear baggage door or trunk door TD of a car. The mat has a first mat side M1 for disposition on the portion of the surface S of the vehicle to be protected, and a second mat side M2 facing the exterior and away from the vehicle V. The rack R is mounted in contact with the second mat side M2.

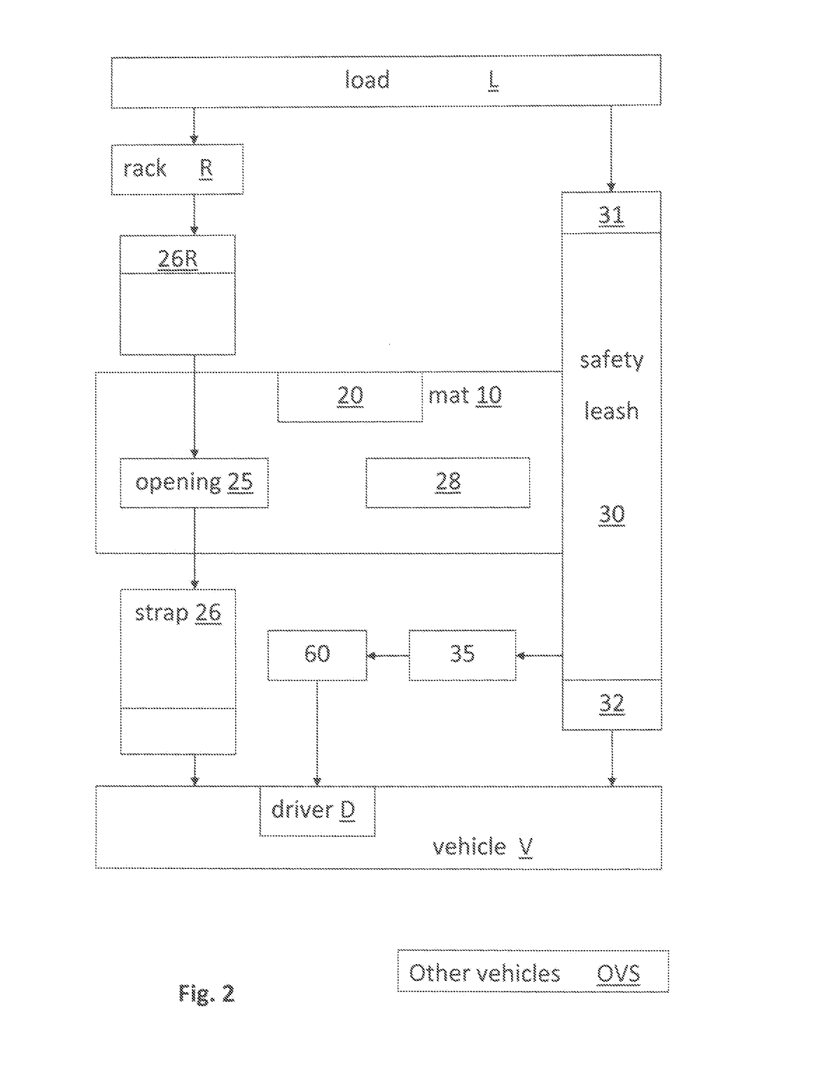

The mat 10 may be releasably retained on the surface S of the vehicle V by various means, such as for example magnetic strips or magnetic pieces 27 disposed on the first mat side M1. In FIG. 1, a corner of the mat 10 is folded to expose the first mat side M1 and a magnet piece 27. Openings 25 are provided and appropriately disposed on the mat 10 to permit passage therethrough from the first mat side M1 to the second mat side M2, and vice versa, of straps 26 used to attach the rack R to the vehicle V. As shown in FIG. 2, the strap 26 has a strap-rack-end 26R for fixed but releasable attachment to the rack R and a strap-vehicle-end 26V for fixed but releasable attachment to the vehicle V. The rack R, for example a bicycle rack, may be mounted on the vehicle V for supporting a load L, for example, one or more bicycles. The mat 10 so disposed prevents damage to the vehicle from the rack R and the load L, from scratching and rubbing against or otherwise damaging the surface S.

The mat 10 may be shaped in any desired geometrical form configured to provide protection, but in an embodiment, the mat may be of substantially rectangular shape and may have laterally extending arms or flaps 50. The mat 10 may have additional protective flaps 50 which flaps may be provided with one or more openings 25. The flaps 50 may adopt any practical form to provide protection to the surface S, but in an embodiment, the flaps 50 may be substantially rectangular or semi-circular. Furthermore, the mat 10 may include one or more reversibly closeable openings 28, appropriately disposed to allow a selected portion of surface PDS covered by the mat, to become visible when opened, for example a portion of the vehicle V supporting a license plate or a lock. To enhance travel security during times of reduced visibility, the mat 10 may be provided with optical reflectors 40 or with reflective means 40 mounted on the second mat side M2 facing the exterior, away from the vehicle.

The mat includes a safety leash 30 having a first leash end 31 for fixed but releasable, or reversible, attachment in retention of the load L, and a second leash end 32 for fixed but releasable attachment to the vehicle V, to prevent the load L from becoming unintentionally disengaged from the vehicle. The safety leash 30 may be threaded through an opening 25 in the mat 10 and may be affixed to the mat either fixedly or loosely. Each one of the leash ends 31 and 32 may have a hook, a spring-loaded fastener, or any suitable fastener appropriate for the task.

As shown in FIG. 2, the safety leash 30 may be coupled to a sensing device 35, which in turn, may be coupled in communication, either wired or wireless, with an alarm system 60. The alarm system 60 may activate an alarm signal to alert, for example, at least a driver D of the vehicle, or at least one other interested party, should the load become disengaged from the rack R. A wide range of alarm signals may be appropriate, but in a preferred embodiment, visual alert signals, or audio alert signals, or tactile signals may be used, either each one alone or in combination.

The sensing device 35 may be configured to sense a tensile force in the safety leash 30. A tensile force in excess of a predetermined threshold may be indicative of the load being disengaged or becoming disengaged from the rack. In response to the tensile force exceeding the predetermined threshold, the sensing device may trigger the alarm system 60 to activate an alarm signal. The sensing device 35 and the alarm system 60 may be disposed either on the vehicle V or on the safety leash 30, together or separately.

The sensing device 35 may be configured for example as a simple spring-loaded switch that closes or opens an electrical circuit when a predetermined force biases the spring in excess of the threshold. When the threshold is exceeded, the alarm system 60 is triggered to emit a warning signal to at least the driver D. Comparable spring-loaded switch systems are available off-the-shelf, such as for example doorbell buttons. The doorbell button itself is one unit disposed in wireless communication with a second alarm-ringing unit like the bell, which may be disposed at a distance away by no more than a few dozens of meters from the doorbell button. Depressing the doorbell button causes the bell to ring. There is therefore no need to further describe the sensing device 35 and the alarm system 60.

The sensing device 35 may also detect rupture of the leash 30. In practice, one may consider for example, a thin wire threaded into the leash 30. Rupture of the leash 30 also means rupture of the thin wire, which effect may be used to open or close an electric circuit, the consequence of which will be an alert signal delivered by the alarm system 60 to at least the driver D.

A portion of the mat 10 may be formed into a closable pocket 20 for housing therein one or more items such as for example, the safety leash 30, mat accessories ACC, tools, and other items of convenience. Accessories ACC may include a license plate 35 to be attached to the load L, to the rack R, or to the mat 10. The mat 10 may be configured as a pliable and foldable mat, amenable to being stowed in the interior of the vehicle V.

The method for preventing damage to a vehicle from either a rack R mounted on the vehicle V, or from a load L mounted on the rack, includes draping the mat 10 intermediate between a surface of the vehicle and the rack. Damage may include, but is not be limited to scratches, dents, and the like. Prevention of damage to the vehicle is effected both when the vehicle is stationary and in motion.

The method also provides for prevention of damage to other vehicles OVS than the original load-carrying vehicle V, by use of the safety leash 30, securely attached at a first safety leash end 31 to the load and at a second safety leash end 32, to the vehicle. Such attachment may prevent the load L from becoming disengaged from the vehicle V, from bouncing freely upon the road and from hitting or being hit by other vehicles OVS either stationary or in motion. As described hereinabove, the system and method include activating an alarm signal when the load L becomes disengaged from the rack R, and further include activating an alert signal when the safety leash 30 breaks.

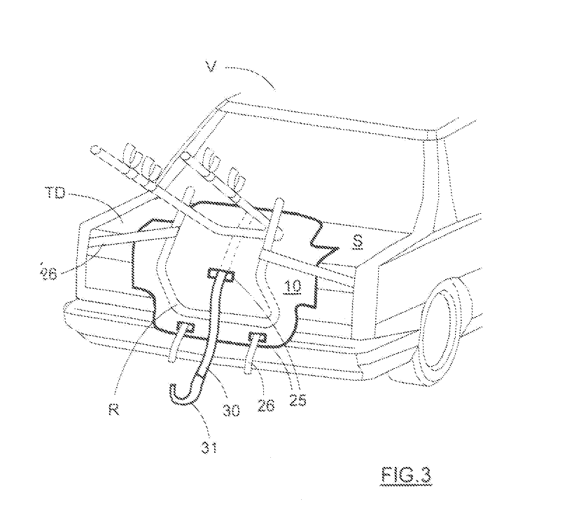

FIG. 3 is an isometric view of the back of the vehicle V, where the mat 10 is draped over the trunk door TD. For the sake of clarity, the mat 10 with the opening 25 and the safety leash 30 is shown, together with the rack R and the straps 26

For use, the mat 10 is disposed on the surface S of the vehicle V to be protected, for example after being retrieved from stowage, such as say from out of the trunk of the vehicle. The mat 10 is then disposed with the first mat side M1, having magnet pieces 27, on the surface S, and the leash 30 may be retrieved out of the pocket 20. Some portion(s) of the mat, such as the second leash end 32 for example, may be introduced into the trunk, through the interstice that opens next to the rear window, when the trunk door is open, and before the trunk door TD is closed. If the communication is not wireless, then wires may also be entered into the trunk interstice in the same manner.

The rack R is then disposed on the second mat side M2. Straps 26 pertaining to the rack R may be passed through opening(s) 25 and be rack is then fixedly secured to the vehicle V by tensioning the straps. In turn, the load L, such as at least a bicycle for example, is mounted on the rack R and the first leash end 31 is affixed to the load. Should the load L become disengaged from the rack R, then tension will be created in the leash 30, which tension will be detected by the sensing device 35.

In an embodiment, the sensing device 35 and the alarm system 60 may be disposed in the interior of the vehicle V, such as in the trunk for example. In such a configuration, the second leash end 32 may be fixedly attached to the sensing device 35, say by use of a hook, or a spring-loaded retention hook, not shown in the Figs., and the sensing device 35 may be coupled to the safety leash 30, as shown in FIG. 2. Alternatively, the second leash end 32 may be coupled to the sensing device 35 that is firmly attached to the vehicle V. When the sensing device 35 detects in the leash 30 a tension stress higher than a predetermined threshold, the alarm system 60 will be triggered. Communication between the sensing device 35 and the alarm system 60 may be established by wire or be wireless.

In another embodiment, the sensing device 35 may be disposed on the mat 10 and the alarm system 60 may be disposed in the interior of the vehicle V. In that case, the second leash end 32 may be fixedly attached to the vehicle V, on the exterior or in the interior of the trunk for example.

While the invention has been illustrated and described in detail in the drawings and foregoing description, such illustration and description are to be considered illustrative or exemplary and non-restrictive; the invention is thus not limited to the disclosed embodiments. Variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be considered as limiting the scope.

Although the present embodiments have been described to a certain degree of particularity, it should be understood that various alterations and modifications could be made without departing from the scope of the invention as hereinafter claimed.

### REFERENCE SIGNS LIST

10 mat
20 mat pocket
25 openings in the mat
26 straps
26R strap-rack-end
26V strap-vehicle-end
27 magnets
28 reversibly closeable opening
30 safety leash
31 first safety leash end
32 second safety leash end
35 sensing device
37 license plate
40 reflectors, reflective means
50 mat flaps
60 alarm system
ACC accessories
D driver
L load
LP license plate
M1 first mat side
M2 second mat side
PDS portion of the surface of the vehicle
S surface of the vehicle
TD trunk door
V vehicle
R rack

1. A vehicle mat system for preventing damage caused to a surface of a vehicle, the system comprising:
a rack mounted on the vehicle and a load supported by the rack, and
a mat made of pliable and foldable material having a first mat side and a second mat side, the second mat side being draped in contact over the surface for preventing damage thereto,
the system being characterized in that:
the mat includes at least one opening opened for passage from the first mat side to the second mat side, where the at least one opening is selected from a group consisting of a permanently open opening and a reversibly closeable opening, and
the mat is disposed intermediate between the rack and the surface for protection thereof from damage caused by the rack and by the load.

2. The system of claim 1, further comprising:
a safety leash having:
a first leash end configured for reversible fixed coupling to the load, and
a second leash end configured for reversible fixed coupling to the vehicle, the safety leash being configured to prevent unintentional detachment of the load from the vehicle, to prevent causing damage to other vehicle(s).

3. The system of claim 2, further comprising:
a sensing device configured to operate in association with the safety leash to detect unintentional disengagement of the load from the rack, and
an alarm system coupled to the sensing device, where the alarm system is configured to deliver an alert signal to at least a driver of the vehicle when the load becomes detached from the rack.

4. The system of claim 1, wherein:
the rack includes at least one strap having a strap-rack-end fixedly attached to the rack and a strap-vehicle-end fixedly but releasably coupled to the vehicle, where the at least one strap is loaded in tension to bias the rack against the vehicle, and
the system being further characterized in that:
the at least one opening in the mat is configured for passage therethrough of the at least one strap.

5. The system of claim 1, wherein:
the at least one reversibly closeable opening is configured to allow to uncover at least one of a predetermined portion of the surface, and
the predetermined portion of the surface is selected alone and in combination from a group including a license plate of the vehicle and a lock of the vehicle.

6. The system of claim 1, wherein
the mat includes a mat pocket for storing therein at least the safety leash.

7. The system of claim 1, wherein
optical reflective material is attached to the first mat side, and
the mat is foldable.

8. The system of claim 1, wherein
the rack is a bicycle rack.

9. The system of claim 1, wherein
the load includes at least one bicycle.

10. The system of claim 1, wherein
the mat is draped onto a trunk door of the vehicle.

11. The system of claim 3, wherein
the sensing device is disposed on one of the safety leash and the vehicle.

12. The system of claim 3, wherein
the alarm system is disposed on one of the safety leash and in the vehicle.

13. The system of claim 3, wherein
the alert signal is selected alone and in combination from a group including a visual alert signal, and an audio alert signal.

14. The system of claim 6, wherein
the mat pocket is configured for storing therein accessories including a license plate configured for attachment to one of the load, the rack, and the mat.

15. A method for use of a mat for preventing damage to a surface of a vehicle and for preventing detachment of a load from the vehicle, the method comprising the steps of:
securing the mat made of pliable and foldable material onto the surface,
coupling a rack to the vehicle by use of at least one strap, and
supporting the load on the rack,
the method being characterized by comprising the steps of:
providing the mat with at least one opening opened for passage therethrough of the at least one strap passing from the rack to the vehicle, and
disposing the mat intermediate between the rack and the surface for protecting the vehicle from damage caused by the rack and by the load.

16. The method of claim 15, further comprising the steps of:
providing the mat with a safety leash having a first leash end and a second leash end,
coupling the first leash end in reversible fixed coupling to the load and coupling the second leash end in reversible fixed coupling to the vehicle, where the safety leash is configured for preventing unintentional detachment of the load from the vehicle and for preventing the load from causing damage to other vehicle(s).

17. The method of claim 15, further comprising the steps of:
providing a sensing device operating in association with the safety leash,
coupling the sensing device in communication with an alarm system,
using the sensing device for detection of disengagement of the load from the rack, and
delivering an alert signal to at least a driver of the vehicle when the load becomes detached from the rack.

18. The method of claim 17, further comprising the step of:
using the sensing device for detection of rupture of the safety leash, and
delivering the alert signal upon rupture of the safety leash.
